(19) United States
(12) Patent Application Publication
(10) Pub. No.: US 2008/0022571 A1
(43) Pub. Date: Jan. 31, 2008

(54) Method of forming display objects on a magnet sheet and a magnet sheet formed with display objects by the same

(76) Inventor: Konomu Ogikubo, Ibaraki (JP)

Correspondence Address: WENDEROTH, LIND & PONACK, L.L.P., 2033 K STREET N. W., SUITE 800, WASHINGTON, DC, 20006-1021, US

(21) Appl. No.: 11/703,144

(22) Filed: Feb. 7, 2007

(30) Foreign Application Priority Data
Jul. 28, 2006 (JP) 2006-205839

(51) Int. Cl. G09F 7/04

(52) U.S. Cl. 40/600

(57) ABSTRACT

An object of the present invention is to provide a method of forming display objects on a magnet sheet and a magnet sheet formed with display objects by this method, wherein display objects with good visibility can be formed on a magnetic attachment surface and the display objects formed on the magnetic attachment surface are not transcribed on the subjected surface even though the magnet sheet is exposed to high temperature heat in the magnetization state and the magnetization state continues long time.

A method of the present invention comprises of steps of process-forming mirror images 2 of display objects such as characters and figures on a surface of a rotating roll 1 by closing up minute pores by a laser process; and transcribing desired display objects 5 such as characters and figures on a magnetic attachment surface of a magnet sheet 4 by pressing the heated rotating roll to the magnetic attachment surface 4a.

### BACKGROUND OF THE INVENTION

1. Field of the Invention

The present invention is related to a method of forming display objects on a resin bond magnet bonding ferromagnetic powder by a synthetic resin bonding agent, particularly the method forming display objects on a magnetic attachment surface of a magnetic sheet and a magnetic sheet formed with display objects by this method, wherein the display objects are superior in visibility and the display objects are not transcribed on the magnetized surface.

2. Prior Art

Conventionally, displays of countries of origin and manufactures' names have not been displayed nor formed on magnet sheets of the original fabric rolls such as 10 meter roll and 20 meter roll which are provide to processing makers, although they have been displayed and formed on magnet sheets of packages and the like of products for end consumers. However, according to social trends of clarification of responsibility of manufactures, displays such as manufacturer's names and countries of origin are required to be surely formed and identified by as far as end consumers, even though the products are cut from original fabric rolls to pieces.

[Patent Reference 1] JP-A 2004-29095

Since printed sheets such as color films formed with display objects are adhered on non magnetic attachment surfaces of magnet sheets which become front surfaces during use as products, displays such as manufactures' names and countries of origin can not be formed on these surfaces. Therefore, the displays had to be formed on magnetic attachment surfaces which are rear surfaces.

However, there have been problems in which when display objects such as ink for printing and paint are formed on the magnet attachment surface which is magnetized with a magnetic body in the magnet sheet, the magnetic sheet is exposed to high temperature heat while the magnetic sheet is magnetized in a state of use and the magnetization state continues long time, thereby the ink and the paint of the display objects have been transcribed on a subjected surface. Further, since most colors of the magnet sheet itself are blackish dark, there has been a difficulty of forming display objects with good visibility.

### SUMMARY OF THE INVENTION

An object of the present invention is to provide a method of forming display objects on a magnet sheet and a magnet sheet formed with display objects by this method, wherein display objects with good visibility can be formed on a magnetic attachment surface and the display objects formed on the magnetic attachment surface are not transcribed on a subjected surface even though the magnet sheet is exposed to high temperature heat in the magnetization state and the magnetization state continues long time.

### BRIEF DESCRIPTION OF THE DRAWINGS

FIG. 1 is a schematic diagram showing a method of forming display objects on a magnet sheet related to the present invention.

### DESCRIPTION OF PREFERRED EMBODIMENTS

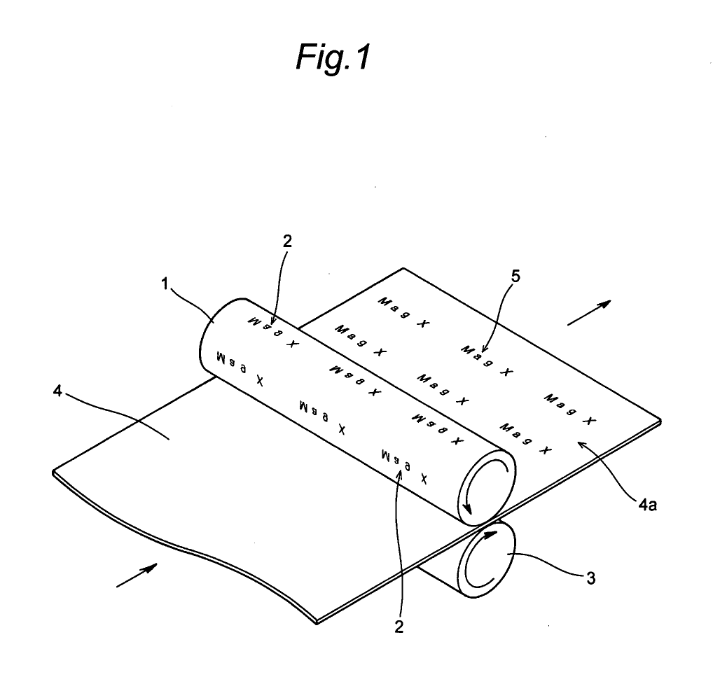

In a method of forming display objects on a magnet sheet related to the present invention, as shown in FIG. 1, a rotating roll 1 with a rough surface on which mirror images 2 of desired display objects such as characters and figures (symmetrical images like images reflected on a mirror) are entirely formed by closing up minute pores by a laser processing is arranged with a roll 3 opposed to each other with a slight space. A synthetic resin material is mixed with magnetic powder and extruded to form into a sheet form by a calendar processing and others to form a long magnet sheet 4 (with one surface of non magnetic attachment surface which is formed with a various types of display objects and the other surface of magnetic attachment surface magnetized with a magnetic body). The magnetic attachment surface 4a of the magnet sheet 4 is passed through between the heated rotating roll 1 and roll 3 which are rotating at a constant speed, while the magnetic attachment surface 4a opposed to the heated surface of the rotating roll 1 is being pressed continuously. Thereby, as in FIG. 1, on the magnetic attachment surface 4a of the magnet sheet 4 the mirror images 2 of the display objects are transcribed as a mold and desired display objects 5 such as characters and figures are automatically transcribed and formed in the form of reversed concave and convex.

The mirror images 2 of the display objects formed on the rotating roll 1 are formed of a rough surface which includes dots of minute pores and recesses formed by a laser processing and lines continuing the dots, and sizes and rough surface rates of the mold to be transcribed can be freely established by changing density and depth of minute pores and recesses by controlling laser. That means, display objects appear dark when density of dots and lines is high, and appears light when the density is low. And when depth of dots and lines is small (e.g. several μm), the display objects formed on the magnet sheet 4 is formed of a rough surface made of concave dots and lines with such slight roughness that magnetizability of the magnet sheet 4 can not be affected. Further, as means of forming the mirror images 2 of the display objects with rough surface on the rotating roll 1, included are others but laser processing, for example, a sand blast processing in which a minute polishing agent is sprayed from a nozzle by compressed air, and a portion which is not protected with a masking sheet is removed to form a rough surface having pattern.

Although the rotating roll 1 may be exclusively used for forming display objects, it may be also used for a mill roll and a feed roll which are used for manufacturing the magnet sheet. And when the mirror images 2 of the display objects are laser processed, a heating roll may be directly processed, but the mirror images of the display objects may be formed on the plated surface which is provided on the rotating roll 1 by a laser processing because the depth of the laser process can be made small to several μm. A heating member is incorporated inside this rotating roll 1 to heat control the outer circumference surface into appropriate temperature. The roll 3 may be rotary driven for itself, but it may be provided with no rotary driving mechanism as a free roll.

Further, with regard to the magnet sheet 4 thus formed with display objects 5, the magnetic attachment surface 4a may be coated with shift inhibitor at thickness of about several μm to protect the magnet sheet from shifting to a magnetic body. And the magnetic attachment surface 4a is multiply magnetized alternatively with N pole and S pole and the non magnetic attachment surface is coated with print sheets made of quality paper, coated paper, synthetic paper and synthetic resin film. Order of processing steps of forming display objects, magnetizing, and coating print sheets is not necessarily limited.

With the above mentioned method comprising steps of process-forming the mirror images of display objects such as characters and figures on the surface of the rotating roll; and transcribing desired display objects such as characters and figures on the magnetic attachment surface of the magnet sheet by pressing the heated rotating roll to the magnetic attachment surface, the display objects are formed on the magnetic attachment surface of the magnet sheet without using ink, paint and the like, thereby there is no fear of transcribing the display objects to the magnetic body magnetized with the magnet sheet.

Further, since minute pores are closed up to form the mirror images of the display objects formed on the surface of the rotating roll, and the display objects to be transcribed on the magnetic attachment surface of the magnet sheet are formed of a rough surface, the display objects of the magnet sheet can be formed of such rough surface that unevenness of concave and convex can be rarely felt, thereby there is no fear of affecting magnetizabilitiy of the magnet sheet. And the display objects formed of the rough surface appears pale and raised from a smooth surface portion of the magnet sheet can sufficiently ensure visibility compared with the conventional display objects such as ink which did not perform good visibility because of dark color of the magnet sheet itself.

Further, since the mirror images of the display objects are formed by laser processing on the surface of the rotating roll, the mirror images of the display objects can be easily formed on the rotating roll compared with curving processing, and density of dots of minute pores and recesses and lines and the process depth can be easily established.

Further, with the magnet sheet of the present invention which is used while the magnetic attachment surface is being magnetized with a magnetic body, wherein desired display objects such as characters and figures are transcribed on the magnetic attachment surface by pressing on the magnetic attachment surface a heated surface of the rotating roll which is formed with the mirror images of the display objects such as characters and figures, the display objects are formed without using ink, paint and the like on the magnetic attachment surface. Thereby there is no fear of transcribing the display objects on the magnetic body magnetized with the magnet sheet.

Further, since the magnetic attachment surface of the magnetic sheet transcribed and formed with the display objects is coated with a shift inhibitor, there is no fear of shifting the magnetic sheet to the magnetized magnetic body.

What is claimed is:

1. A method of forming display objects on a magnet sheet comprising steps of:
process-forming mirror images of display objects such as characters and figures on a surface of a rotating roll; and
transcribing desired display objects such as characters and figures on a magnetic attachment surface of the magnet sheet by pressing said rotating roll which is heated to the magnetic attachment surface.

2. The method of forming display objects on the magnet sheet according to claim 1, wherein minute pores are closed up to form the mirror images of the display objects formed on the surface of the rotating roll, and the display objects to be transcribed on the magnetic attachment surface of the magnet sheet are formed of a rough surface.

3. The method of forming display objects on the magnet sheet according to claim 1, wherein the mirror images of the display objects are formed by laser processing on the surface of the rotating roll.

4. The method of forming display objects on the magnet sheet according to claim 1, wherein the magnet sheet consists of one surface which is non magnetic attachment surface to be formed with various types of display objects and the other surface which is a magnetic attachment surface to be magnetized with magnetic body.

5. A magnet sheet which is used while a magnetic attachment surface is being magnetized with a magnetic body, wherein desired display objects such as characters and figures are transcribed on the magnetic attachment surface by pressing on the magnetic attachment surface a heated surface of a rotating roll which is formed with mirror images of the display objects such as characters and figures.

6. The magnetic sheet according to claim 5, wherein the magnetic attachment surface of the magnetic sheet transcribed and formed with the display objects is coated with a shift inhibitor.

7. The magnetic sheet according to claim 5, wherein the magnetic sheet consists of one surface which is non magnetic attachment surface to be formed with various types of display objects and the other surface which is a magnetic attachment surface to be magnetized with magnetic body.
